(19) United States
(12) Patent Application Publication
(10) Pub. No.: US 2026/0238004 A1
(43) Pub. Date: Aug. 13, 2026

(54) Protection Coordination for Mitigating Sympathetic Tripping in Distributed Energy Resource-Integrated Power Systems

(71) Applicant: Board of Regents, The University of Texas System, Austin, TX (US)

(72) Inventors: Ahmed Khalid Almoola, San Antonio, TX (US); Sara Ahmed, San Antonio, TX (US); Nikolaos Gatsis, San Antonio, TX (US)

(21) Appl. No.: 19/532,791

(22) Filed: Feb. 6, 2026

Related U.S. Application Data
(60) Provisional application No. 63/755,480, filed on Feb. 7, 2025.

(51) Int. Cl. H02J 3/001; H02J 3/38; H02J 13/10; H02J 13/36

(52) U.S. Cl. CPC H02J 3/001; H02J 3/381; H02J 13/10; H02J 13/36

(57) ABSTRACT

Computer systems, methods, and memory media for configuring a power distribution network. The network includes a plurality of distributed energy resources (DERs) and first and second relays. A first fault scenario at a first fault location for the power distribution network has a designated fault zone that includes the first relay, so that first relay is configured to act as a primary relay for the first fault scenario. The first fault location is not in a designated fault zone of the second relay. The first and second relays have first and second operating times determined based on first and second time dial settings (TDSs) and pickup setting (PSs), respectively. The TDSs and PSs are determined by performing a minimization operation on a summation of a plurality of summands that includes the first operating time and an amount by which the first operating time exceeds the second operating time.

### PRIORITY CLAIM

This application claims the benefit of priority to U.S. Patent Application Ser. No. 63/755,480, filed Feb. 7, 2025, entitled “Optimal Protection Coordination for Mitigating Sympathetic Tripping in DER-Integrated Power Systems”, which is incorporated herein by reference in its entirety as though completely set forth herein.

### BACKGROUND

### Technical Field

The present application relates to power distribution infrastructure, and more specifically to sympathetic tripping mitigation in distributed energy resource (DER)-integrated power systems.

### Description of the Related Art

The increasing utilization of distributed energy resources (DERs) such as rooftop photovoltaics, battery energy storage, and community-scale inverters has substantially changed distribution system fault characteristics and protection requirements. Inverter-based resources typically contribute limited and often control-limited short-circuit current, while variable output and bidirectional power flows introduce time-varying fault-current levels and altered directionalities that conventional overcurrent and directional relays were not designed to accommodate. These changes, combined with existing radial and meshed distribution topologies, raise the likelihood of miscoordination between protective devices and increase incidents of sympathetic tripping—where a relay device inappropriately operates in response to a fault—leading to unnecessary outages and degraded system reliability. Protective relays are configured to trip (breaking the circuit) in response to detected fault currents in a designated protective zone, also called a fault zone. Sympathetic tripping occurs when a protective relay trips in response to a fault that occurs in a different zone from its designated fault zone. Traditional remedies such as tightened relay settings, increased reliance on directional elements, and manual coordination are challenged by the dynamic behavior of DERs and the need to preserve selectivity, sensitivity, and security. As a result, power systems operators face growing complexity in maintaining stable protection schemes that can adapt to rapid changes in generation patterns and maintain service continuity. Thus, improvements in the field are desired.

### SUMMARY

Embodiments described herein relate to computer systems and methods for configuring operational settings of a plurality of protective relays in a DER power distribution network.

In some embodiments, a power distribution network includes a first relay and a second relay. The first relay is configured with a first time dial setting and a first pickup setting and is configured to operate as a primary relay for a first fault scenario at a first fault location, where a first operating time for that scenario is determined at least in part by the first time dial setting and the first pickup setting. The second relay is provided with a second time dial setting and a second pickup setting and has a second operating time for the same first fault scenario determined at least in part by the second time dial setting and the second pickup setting. The first fault location is not within a designated fault zone of the second relay. The first and second time dial settings and the first and second pickup settings are chosen by performing a minimization operation of a summation of multiple terms, the terms including the first operating time and a term representing the amount by which the first operating time exceeds the second operating time.

In some embodiments, a third relay is configured with a third TDS and a third PS that determine its operating time, and the third relay is configured to act as backup relay for the first fault scenario. The first fault scenario produces a third fault current at the third relay, and the plurality of summands may further include the third operating time.

Advantages of the described embodiments may include one or more of the following:

Improved coordination between primary and backup protective devices by jointly selecting time-dial and pickup settings through a minimization calculation that penalizes disordered operating times, thereby reducing instances of sympathetic or unnecessary tripping.

Preservation of selectivity, sensitivity, and security of protection schemes while accommodating the reduced and time-varying short-circuit contributions of DER power networks.

Explicit accommodation of multiple fault scenarios and multiple relays (including identification and sizing of legitimate backup relays), enabling settings that are robust across a wide range of operating conditions and fault locations.

Ability to incorporate designated fault zones and device-specific constraints (e.g., allowable pickup ranges, time-dial limits, and required coordination margins) directly into the optimization, producing implementable settings for existing protection equipment.

Reduced manual engineering effort and coordination time by automating the selection of operational settings, facilitating faster planning updates as DER penetration or network topology changes.

Scalability to large distribution networks and to many relays and contingencies, allowing system-wide or substation-level re-coordination in planning or near-real-time operational workflows.

Compatibility with current relay hardware and configuration processes (settings are changed, not fundamental device architectures), enabling deployment without wholesale equipment replacement.

Improved system reliability and customer service continuity through fewer unnecessary outages and faster, more selective fault clearing; potential reductions in reliability indices (e.g., System Average Interruption Duration Index (SAIDI) and/or System Average Interruption Frequency Index (SAIFI)) and associated economic benefits.

Flexibility to include uncertainty models or scenario weighting (for example, variable DER outputs or bi-directional flows) so that settings can be tuned for worst-case, probabilistic, or expected operating envelopes.

Amenability to integration with utility control systems (e.g., Supervisory Control and Data Acquisition (SCADA) and/or Distributed Energy Resource Management Systems (DERMS)) and protection planning tools to support periodic or event-driven re-coordination as network conditions evolve.

This Summary is intended to provide a brief overview of some of the subject matter described in this document. Accordingly, it will be appreciated that the above-described features are only examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

FIG. 1 is a block diagram of a computing system, according to some embodiments;

FIG. 2 is a flowchart diagram illustrating a method for determining operational settings of relays in a distributed energy resource (DER) power distribution network, according to some embodiments;

FIG. 3 is a schematic layout of an example DER power distribution network, according to some embodiments;

FIG. 4A is a graph illustrating operating times for the four relays of the DER power distribution network in FIG. 4 according to previous implementation;

FIG. 4B is a graph illustrating operating times for the four relays of the DER power distribution network in FIG. 4, according to some embodiments; and

FIG. 5 is a block diagram of a power relay, according to some embodiments.

Although the embodiments disclosed herein are susceptible to various modifications and alternative forms, specific embodiments are shown by way of example in the drawings and are described herein in detail. It should be understood, however, that drawings and detailed description thereto are not intended to limit the scope of the claims to the particular forms disclosed. On the contrary, this application is intended to cover all modifications, equivalents and alternatives falling within the spirit and scope of the disclosure of the present application as defined by the appended claims.

This disclosure includes references to “one embodiment,” “a particular embodiment,” “some embodiments,” “various embodiments,” or “an embodiment.” The appearances of the phrases “in one embodiment,” “in a particular embodiment,” “in some embodiments,” “in various embodiments,” or “in an embodiment” do not necessarily refer to the same embodiment. Particular features, structures, or characteristics may be combined in any suitable manner consistent with this disclosure.

Reciting in the appended claims that an element is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors.

As used herein, the terms “first,” “second,” etc. are used as labels for nouns that they precede, and do not imply any type of ordering (e.g., spatial, temporal, logical, etc.), unless stated otherwise. As used herein, the term “or” is used as an inclusive or and not as an exclusive or. For example, the phrase “at least one of x, y, or z” means any one of x, y, and z, as well as any combination thereof (e.g., x and y, but not z). In some situations, the context of use of the term “or” may show that it is being used in an exclusive sense, e.g., where “select one of x, y, or z” means that only one of x, y, and z are selected in that example.

In the following description, numerous specific details are set forth to provide a thorough understanding of the disclosed embodiments. One having ordinary skill in the art, however, should recognize that aspects of disclosed embodiments might be practiced without these specific details. In some instances, well-known, structures, computer program instructions, and techniques have not been shown in detail to avoid obscuring the disclosed embodiments.

### DETAILED DESCRIPTION

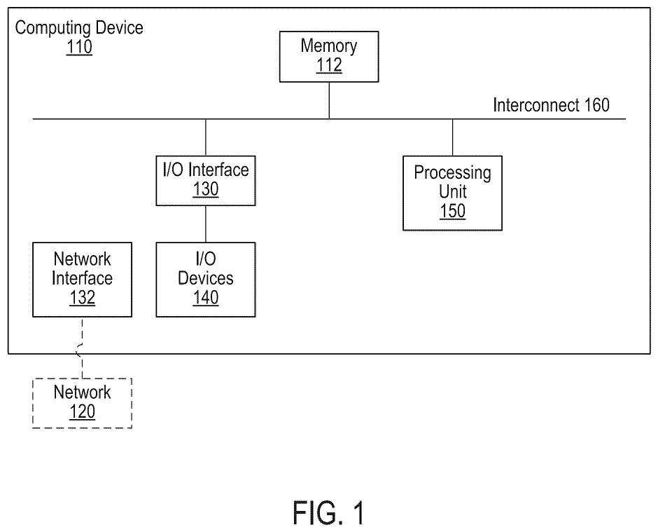

### FIG. 1—Example Computer System

FIG. 1 is a block diagram of one embodiment of computing device (which may also be referred to as a computing system) 110 is depicted, which may be utilized in accordance with some embodiments. The computing device 110 may be used to implement various portions of this disclosure. Computing device 110 may be any suitable type of device, including, but not limited to, a personal computer system, desktop computer, laptop or notebook computer, mainframe computer system, web server, workstation, or network computer. As shown, computing device 110 includes processing unit 150, storage 112, and input/output (I/O) interface 130 coupled via an interconnect 60 (e.g., a system bus). I/O interface 130 may be coupled to one or more I/O devices 140. Computing device 110 further includes network interface 132, which may be coupled to network 120 for communications with, for example, other computing devices.

In various embodiments, processing unit 150 includes one or more processors. In some embodiments, processing unit 150 includes one or more coprocessor units. In some embodiments, multiple instances of processing unit 150 may be coupled to interconnect 160. Processing unit 150 (or each processor within 150) may contain a cache or other form of on-board memory. In some embodiments, processing unit 150 may be implemented as a general-purpose processing unit, and in other embodiments it may be implemented as a special purpose processing unit (e.g., an ASIC). In general, computing device 110 is not limited to any particular type of processing unit or processor subsystem.

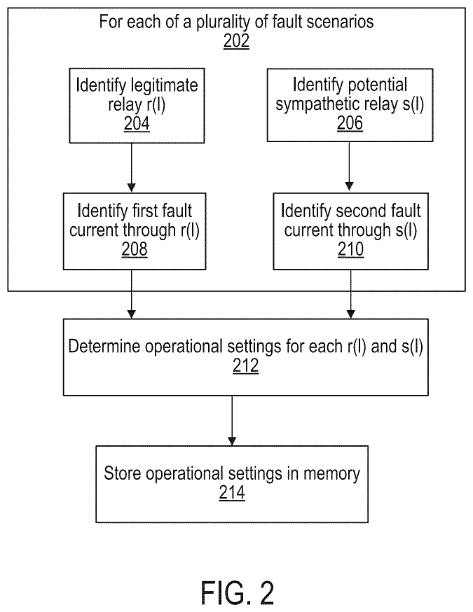

As used herein, the term “module” refers to circuitry configured to perform specified operations or to physical non-transitory computer readable media that store information (e.g., program instructions) that instructs other circuitry (e.g., a processor) to perform specified operations. Modules may be implemented in multiple ways, including as a hardwired circuit or as a memory having program instructions stored therein that are executable by one or more processors to perform the operations. A hardware circuit may include, for example, custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like. A module may also be any suitable form of non-transitory computer readable media storing program instructions executable to perform specified operations. For example, the processor may execute the program instructions to determine operational settings for a plurality of relays in a DER power network, as described in reference to FIG. 2, below.

Memory 112 is usable by processing unit 150 (e.g., to store instructions executable by and data used by processing unit 150). Memory 112 may be implemented by any suitable type of physical memory media, including hard disk memory, floppy disk memory, removable disk memory, flash memory, random access memory (RAM-SRAM, EDO RAM, SDRAM, DDR SDRAM, RDRAM, etc.), ROM (PROM, EEPROM, etc.), and so on. Memory 112 may consist solely of volatile memory, in one embodiment. Memory 112 may store program instructions executable by computing device 110 using processing unit 150, including program instructions executable to cause computing device 110 to implement the various techniques disclosed herein.

I/O interface 130 may represent one or more interfaces and may be any of various types of interfaces configured to couple to and communicate with other devices, according to various embodiments. In one embodiment, I/O interface 130 is a bridge chip from a front-side to one or more back-side buses. I/O interface 130 may be coupled to one or more I/O devices 140 via one or more corresponding buses or other interfaces. Examples of I/O devices include storage devices (hard disk, optical drive, removable flash drive, storage array, SAN, or an associated controller), network interface devices, user interface devices or other devices (e.g., graphics, sound, etc.).

Various articles of manufacture that store instructions (and, optionally, data) executable by a computing system to implement techniques disclosed herein are also contemplated. The computing system may execute the instructions using one or more processing elements. The articles of manufacture include non-transitory computer-readable memory media. The contemplated non-transitory computer-readable memory media include portions of a memory subsystem of a computing device as well as storage media or memory media such as magnetic media (e.g., disk) or optical media (e.g., CD, DVD, and related technologies, etc.). The non-transitory computer-readable media may be either volatile or nonvolatile memory.

### Relay Coordination in Distributed Energy Resource Power Grids

In traditional power systems, relay coordination is achieved through a hierarchy of primary and backup relays. Primary relays are designed to respond to faults within specific protection zones, isolating the affected area from the rest of the network. Backup relays, on the other hand, are configured to operate if a primary relay fails to clear a fault.

To address the limitations of traditional methods in DER-integrated systems, embodiments herein propose a mathematical optimization-based approach for relay coordination. The described embodiments minimize sympathetic tripping while ensuring that primary relays operate faster than relays in neighboring zones, reducing unnecessary relay responses.

Consider a multi-phase unbalanced distribution grid with a set [symbol] ={1, . . . , N} relays. Traditional relay coordination is based upon a set of plausible fault scenarios denoted by [symbol] . Each fault scenario k∈ [symbol] is associated with at least the fault location in the network. For each fault scenario k∈ [symbol] , a relay designated as primary and denoted by p(k)∈ [symbol] is configured to operate. The primary relay is configured to trigger (i.e., to break the circuit, hence isolating the fault) after a configurable operating time, T, has elapsed from the moment when a predetermined level of fault current is detected. The operating time is generally a function of the detected fault current, operational settings of the relay, and/or one or more additional configurable variables or parameters. Specific examples are given below, but other expressions for the operating time may also be used, as desired.

For a subset [symbol] _{b}⊂ [symbol] of the fault scenarios, if the primary relay fails to operate, then a backup relay is designated to operate. The backup relay for fault scenario k∈ [symbol] _{b} is denoted by b(k)∈ [symbol] . Embodiments herein mitigate issues that may occur with overcurrent relays—which respond to the magnitude of the fault current.

The variable I_{F}_{_{k,p(k)}} denotes the fault current through relay p(k) corresponding to fault scenario k∈ [symbol] . The time that the relay operates may be determined by the time-current characteristic. For example, the time-current characteristic Tₚ₍ₖ₎ may determine the operating time for the p(k) corresponding to fault scenario k. Note that, as used herein, the time-current characteristic refers to the function used to determine the operating time; and the operating time is the value that this function produces based on a specific input (e.g., based on the fault current). The characteristic for relay n∈ [symbol] involves the time dial setting, TDSₙ, and the pickup setting, PSₙ; both are adjustable variables. Specifically, the operating time for relay p(k) acting under fault scenario k may be given by:

$${T}_{p ( k )} = A \cdot \frac{T D {S}_{p ( k )}}{{( \frac{{I}_{{F}_{k , p ( k )}}}{{PS}_{p ( k )}} )}^{ρ} - 1} + B \cdot {TDS}_{p ( k )} \qquad ( 1 )$$

where A, B, and ρ are parameters that shape the time-current characteristic curve, with the IEEE and IEC Inverse Time Curves being examples. The fault current through backup relay b(k) responding to scenario k∈ [symbol] _{b} is denoted by I_{F}_{_{k,b(k)}}. The operating time of relay b(k) may be given by:

$${T}_{b ( k )} = A \cdot \frac{T D {S}_{b ( k )}}{{( \frac{{I}_{{F}_{k , b ( k )}}}{P {S}_{b ( k )}} )}^{ρ} - 1} + B \cdot {TDS}_{b ( k )} \qquad ( 2 )$$

Traditional relay coordination includes several constraints. Specifically, TDS and PS values may be constrained within configurable minimum and maximum values as follows:

$$T D {S}_{min} \leq T D {S}_{n} \leq T D {S}_{max} \qquad ( 3 )$$

$$P {S}_{min} \leq P {S}_{n} \leq P {S}_{max} , n ∈ 𝒩 \qquad ( 4 )$$

The relay operating times may also be constrained to be within specified bounds:

$${T}_{min} \leq {T}_{p ( k )} \leq {T}_{max} , k ∈ 𝒦 \qquad ( 5 )$$

$${T}_{min} \leq {T}_{b ( k )} \leq {T}_{max} , k ∈ {𝒦}_{b} \qquad ( 6 )$$

To ensure correct coordination, a minimum coordination time interval (CTI) may be enforced between the operation of primary and backup relays. For each fault scenario where both a primary and a backup relay are designated to operate, the following constraint may be applied:

$${T}_{b ( k )} - {T}_{p ( k )} \geq C T I , k ∈ {𝒦}_{b} \qquad ( 7 )$$

Additionally, the time dial and pickup setting values for backup relays may be constrained to be larger than those for primary relays to maintain the proper sequence of operations:

$${TDS}_{b ( k )} \geq T D {S}_{p ( k )} + Δ \qquad ( 8 )$$

$${PS}_{b ( k )} \geq P {S}_{p ( k )} , k ∈ {𝒦}_{b} \qquad ( 9 )$$

where Δ is a buffer between TDS values.

The traditional coordination formulation minimizes the sum of operating times for primary and backup relays:

$$minimize {\sum }_{k ∈ 𝒦} {T}_{p ( k )} + {\sum }_{k ∈ {𝒦}_{b}} {T}_{b ( k )} \qquad ( 10 )$$

subject to Eqs. (1)-(6)

This problem may be described as a nonlinear (nonconvex) program.

### Sympathetic Tripping Mitigation

Sympathetic tripping occurs when a given relay operates unnecessarily in response to faults on an adjacent feeder (in which a different relay should operate), even though no fault exists in the given relay's designated zone. To model this situation, consider a set of fault scenarios [symbol] that may cause sympathetic tripping; the fault scenario l∈ [symbol] at least specifies the fault location. For each scenario l∈ [symbol] , let s(l)∈ [symbol] denote a relay that may sympathetically trip; and let r(l) be a relay that should legitimately trip. In some embodiments, sets [symbol] and [symbol] may specifically include common fault scenarios, but this is not necessary.

If more than one relay has the potential to sympathetically trip, this situation can be handled by including one or more additional fault scenarios l and defining one or more appropriate functions s(l). Likewise, the specification of the relay r(l) that should legitimately trip may refer either to the primary or backup relay for the specific fault location. Both can be accounted for, with appropriate definitions of the function r(l). The adopted setup that includes the set [symbol] and functions s(l) and r(l) is therefore quite broad and allows for a general formulation that has the potential to mitigate a variety of relay misoperation scenarios.

In some embodiments, a binary variable d is introduced that takes the value 1 if s(l) trips and 0 otherwise. Let I_{SF}_{_{i,s(l)}} be the fault current through relay s(l). Relay s(l) trips when the fault current I_{SF}_{_{i,s(l)}} is greater than the relay pickup current PSₛ₍ₗ₎, in which case we also have that dₗ=1; otherwise, the relay does not trip and dₗ=0. This disjunctive constraint may be mathematically formulated with the big-M method as follows, where M>0 is a large constant (e.g., significantly larger than the other variables in Eqs 11 and 12).

$$P {S}_{s ( l )} \leq {I}_{S {F}_{l , s ( l )}} + M ( 1 - {d}_{l} ) \qquad ( 11 )$$

$${I}_{S {F}_{l , s ( l )}} \leq P {S}_{s ( l )} + M {d}_{l} , l ∈ ℒ \qquad ( 12 )$$

The previous constraint may be interpreted as follows. When dₗ=1, then PSₛ₍ₗ₎≤I_{SF}_{ₛ₍ₗ₎} holds, and (12) does not impose any binding constraint on PSₛ₍ₗ₎ and I_{SF}_{ₛ₍ₗ₎} because M is very large. Likewise, if dₗ=0, it follows that I_{SF}_{ₛ₍ₗ₎}≤PSₛ₍ₗ₎, and (11) does not restrict PSₛ₍ₗ₎ and I_{SF}_{ₛ₍ₗ₎}.

The next step is to model the relay operating time. Specifically, sympathetic tripping occurs when the time when the sympathetically tripped relay triggers is shorter than the operating time of the relay that should legitimately trip. Therefore, it would be desirable to impose the constraint that Tᵣ₍ₗ₎≤Tₛ₍ₗ₎. Because it may be unknown whether this constraint is feasible in a particular scenario, a slack variable uₗ≥0 may be introduced such that Tᵣ₍ₗ₎≤Tₛ₍ₗ₎+uₗ. If the optimization can select uₗ=0, then Tᵣ₍ₗ₎≤Tₛ₍ₗ₎ holds; otherwise, the sympathetically tripping relay operates faster than the legitimate relay by an amount of time given by uₗ. The variable uₗ may be constrained as follows:

$$0 \leq {u}_{l} \leq M {d}_{l} , l ∈ ℒ \qquad ( 13 )$$

The right hand side of (13) sets uₗ to zero if dₗ=0, that is, if relay s(l) does not trip.

Note that the constraint Tᵣ₍ₗ₎≤Tₛ₍ₗ₎+uₗ is meaningful only when dₗ=1. The big-M method may be employed to express the constraint as follows:

$$T D {S}_{r ( l )} ( \frac{A}{{( \frac{{I}_{{F}_{l , r ( l )}}}{P {S}_{r ( l )}} )}^{ρ} - 1} + B ) \leq T D {S}_{s ( l )} ( \frac{A}{{( \frac{{I}_{S {F}_{l , s ( l )}}}{P {S}_{s ( l )}} )}^{ρ} - 1} + B ) + {u}_{l} + {M}^{′} ( 1 - {d}_{l} ) , l ∈ ℒ \qquad ( 14 )$$

where in the left-hand side of (14), the fault current I_{F}_{_{l,r(l)}} through the relay that should legitimately trip is used. The constant M′ may be selected such that M′>M, to preclude any numerical issue that might arise if the optimization selects a large value of uₗ in (13).

The relay coordination objective function may be modified to include (10) as well as to minimize the slack variables uₗ. The optimization problem reads as follows:

$$minimize {\sum }_{k ∈ 𝒦} {T}_{p ( k )} + {\sum }_{k ∈ {𝒦}_{b}} {T}_{b ( k )} + {\sum }_{l ∈ ℒ} {u}_{l} \qquad ( 15 )$$

subject to Eqs. (1)-(6), (8)-(10)

Including the term [symbol] uₗ in the objective function pushes the legitimately tripping relay to act faster than the sympathetically tripping one. In exemplary embodiments, operational settings for the relays p(k), s(k), and/or b(k) may be selected to minimize the summation shown in Equation 15, when the summation is performed over each fault scenario k of a set of fault scenarios [symbol] . The set of fault scenarios may include an exhaustive list of ever possible fault scenario, or alternatively it may only include a subset of more common or more likely fault scenarios. The results of the optimization can be interpreted based on the following conditions:
If dₗ=0, then relay settings {TDSₙ, PSₙ}_{n∈} [symbol] have been produced such that no sympathetic tripping occurs for scenario l.
If dₗ=1 and uₗ>0, then sympathetic tripping at scenario l cannot be avoided. Specifically, relay s(l) will trip faster than r(l) by an amount of time given by uₗ.
If dₗ=1 and uₗ=0, then the produced relay settings {TDSₙ, PSₙ [symbol] have the effect that the intended relay r(l) will trip faster than relay s(l) for scenario l. Therefore, sympathetic tripping is avoided in this case as well.

Some embodiments operate as a mixed-integer nonlinear program (MINLP) to calculate a minimum value for Eq. 15.

### FIG. 2—Flowchart for Mitigating Sympathetic Relay Tripping

FIG. 2 is a flowchart diagram illustrating a method for determining and configuring operational settings for a plurality of relays in a power distribution network, according to some embodiments. The operational settings include a time dial setting (TDS) value and a pickup setting (PS) for each of the plurality of relays of the power distribution network. The TDS values and the PSs contribute to determining the operating time for primary and backup relays, e.g., according to the expressions shown in Equations 1 and 2. The PS value determines the fault current through a particular relay that will cause the relay to trip. A similar expression determines the operating time for other relays, e.g., a sympathetically tripping relay, in terms of its TDS and PS values. In some embodiments, operational settings for the relays may be determined using a computing device prior to deploying the relays in the power distribution network (e.g., based on a model or schematic diagram of the layout of the network). The power distribution network may be deployed utilizing relays configured with the determined operational settings. In some embodiments, deployed relays of an existing power network may be reconfigured according to the operational settings determined through method of FIG. 2. For example, an existing power network may be improved by modifying its relays according to the determined operational settings. Alternatively, operational settings may be redetermined when a power network undergoes a modification to its architecture, layout, or configuration (e.g., if the network is expanded to include additional DERs).

The method shown in FIG. 2 may be used in conjunction with any of the computer systems, memory media, relays, power distribution networks, and/or devices shown in the above Figures, among other devices. In some embodiments, a computer system may include a processor and memory, and the memory may store program instructions executable by the processor to perform the method elements described in reference to FIG. 2. In some embodiments, the described method steps may be directed by one or more processors of a computer system, such as the example computing system shown in FIG. 1. In various embodiments, some of the method elements shown may be performed concurrently, in a different order than shown, or may be omitted. Additional method elements may also be performed as desired. As shown, this method may operate as follows.

At 202, the method steps described in reference to numerals 204-210 may be repeatedly performed for each of a plurality of fault scenarios, l, that may occur at each of a plurality of respective fault locations. For clarity and definitiveness, the methods steps are described in reference to a “first fault scenario” at a “first fault location”. The first fault location is the location where a node has experienced a fault in the first fault scenario. Fault scenarios may occur for a variety of reasons. For example, a fallen tree or inclement weather may disrupt a powerline connected to a DER, or the DER itself may experience a fault. In general, a fault may occur in any scenario that disrupts the flow of current from a DER to other nodes of the power network. In some embodiments, the power distribution network includes nodes where respective distributed energy resources (DERs) are connected. In terms of the first fault scenario, the first fault scenario produces a first fault current at a first relay, a second fault current at a second relay, and potentially a third fault current at a third relay. The methods steps may be subsequently repeated for additional second, third, etc., fault scenario(s) at respective fault location(s).

At 204, a first relay, r(l), is identified that should legitimately trip as a primary relay during the first fault scenario. In some embodiments, the first relay is configured to act as either a primary relay or a backup relay for the first fault scenario. The first relay is configured with a first time dial setting (TDS) and a first pickup setting (PS). A first operating time of the first relay for the first fault scenario is determined based at least in part on the first TDS and the first PS, for example, as shown in Equation 1.

At 206, a second relay, s(l), is identified that may sympathetically trip during the fault scenario. The second relay may be identified as a potential sympathetically tripping relay when the first fault location is not in a designated fault zone (but may be proximate to the designated fault zone) of the second relay. The second relay is configured with a second TDS and a second PS. A second operating time of the second relay for the first fault scenario is determined based at least in part on the second TDS and the second PS.

At 208, a first fault current is determined through the first relay during the first fault scenario. The first fault current is the current that is expected to run through the first relay when the first fault scenario occurs. For example, the first fault current may be calculated via circuit analysis of the power distribution network in the case where one or more faults have occurred as indicated by the fault scenario.

At 210, a second fault current is determined through the second relay during the fault scenario. Similar to the first fault current, the second fault current is the current that is expected to run through the second relay when the first fault scenario occurs, and it may be calculated in a similar manner.

At 212, first operational settings of the first relay and second operational settings of the second relay are determined. For example, the first and second TDS and the first and second PS may be determined. The operational settings of the first and second relays may be determined by performing a minimization operation of a summation of a plurality of summands. An example summation is shown in Equation 15, where the summands include both the first operating time, Tₚ₍ₖ₎, and an amount by which the first operating time exceeds the second operating time, uₗ. The summation shown in Equation 15 additionally includes an operating time of a backup relay, Tb(k), which is described in greater detail below. The summation is performed over each of the plurality of fault scenarios, and operational settings are determined that minimize this summation.

In some embodiments, the first operating time, Tₚ₍ₖ₎, is determined based at least in part on the first TDS and the first PS according to:

$${T}_{p ( k )} = A \cdot \frac{T D {S}_{p ( k )}}{{( \frac{{I}_{{F}_{k , p ( k )}}}{{PS}_{p ( k )}} )}^{ρ} - 1} + B \cdot {TDS}_{p ( k )} ,$$

where Tₚ₍ₖ₎ is the first operating time, TDSₚ₍ₖ₎ is the first TDS, PSₚ₍ₖ₎ is the first PS, I_{F}_{_{k,p(k)}} is a fault current through the first relay during the first fault scenario, and A, B and ρ are parameters.

In some embodiments, the second operating time, Tₛ₍ₖ₎, is determined based at least in part on the second TDS and the second PS according to:

$${T}_{p ( k )} = A \cdot \frac{T D {S}_{p ( k )}}{{( \frac{{I}_{{F}_{k , p ( k )}}}{{PS}_{p ( k )}} )}^{ρ} - 1} + B \cdot {TDS}_{p ( k )} ,$$

where Tₛ₍ₖ₎ is the second operating time, TDSₛ₍ₖ₎ is the second TDS, PSₛ₍ₖ₎ is the second PS, I_{F}_{_{k,s(k)}} is the second fault current through the second relay during the first fault scenario, and A, B and ρ are parameters.

The first operating time may be determined based on the first operational settings and the first fault current. The second operating time may be determined based on the second operational settings and the second fault current, as shown in the equations above.

In some embodiments, when the first operating time does not exceed the second operating time, the amount by which the first operating time exceeds the second operating time is treated as zero.

In some embodiments, the first and second operating times are determined further based at least in part on a plurality of parameters for an institute of electrical and electronics engineers (IEEE) or international electrotechnical commission (IEC) time-current curve.

In some embodiments, performing the minimization operation includes determining a value of a binary variable, dl, that indicates whether the second fault current is sufficient to trigger sympathetic tripping of the second relay for the determined second operational settings.

In some embodiments, the first fault scenario produces a first fault current at the first relay, and the first relay is configured to disconnect a first subcircuit of the power distribution network when a first operating time has elapsed after the first relay detects that the first fault current exceeds the first PS. In some embodiments, the first fault scenario produces a second fault current at the second relay, and the second relay is configured to disconnect a second subcircuit of the power distribution network when a second operating time has elapsed after the second relay detects that the second fault current exceeds the second PS. The values of the first and second TDS and PS may be determined using the expression shown in Equation 15 or a similar expression (e.g., with or without a backup relay), which may advantageously prevent the second relay from triggering a disconnect in one or more fault scenarios.

In some embodiments, the operational settings may further prescribe behavior of a third backup relay in the fault scenario. For example, a third relay, b(l), may be identified that should legitimately trip as a backup relay during the fault scenario, and a third fault current through the third relay during the fault scenario may be determined. In these embodiments, third operational settings of the third relay may be determined by performing the minimization operation on the summation of the plurality of summands, and the plurality of summands may further include a third operating time of the third relay. The third operating time may be determined based at least in part on the third operational settings and the third fault current.

In some embodiments, the second relay is configured to act as the primary relay for a second fault scenario at a second fault location, and the second fault location is not in a designated fault zone of the first relay (i.e., in the second fault scenario, the first relay is a potentially sympathetically tripping relay). In this case, a third operating time of the first relay for the second fault scenario is determined based at least in part on the first TDS and the first PS, and a fourth operating time of the second relay for the second fault scenario is determined based at least in part on the second TDS and the second PS. In these embodiments, the plurality of summands further include the fourth operating time; and an amount by which the fourth operating time exceeds the third operating time. Making this more clear, the summation that is minimized may include both the terms from the first fault scenario, as described above, as well as additional terms where the second relay is designated as r(l) and the first relay is designated as s(l). In general, each of the first, second, and potentially additional relays may be designated as any of r(l), s(l) or b(l) for a particular fault scenario l, and in each case the relays will contribute term(s) to the summation that is to be minimized, according to their designation in the particular fault scenario.

Note that the minimization procedure determines a minimum value for the summation when a plurality of fault scenarios have occurred. The plurality of fault scenarios may include a fault scenario where each different DER in the power distribution network has experienced a fault, and in some embodiments fault scenarios may be considered where multiple DERs have faulted. Each of these fault scenarios provides terms to the summation (e.g., Eq. 15), and after obtaining terms for each fault scenario, the resulting expression is minimized to determine the operational settings of the relays.

At 214, the operational settings for each of the plurality of fault scenarios may be stored in a non-transitory computer-readable memory medium. In some embodiments, the first relay may be configured with the first operational settings, the second relay may be configured with the second operational settings, and/or the third (backup) relay may be configured with the third operational settings, for deployment in a power distribution network.

For clarity, the method of FIG. 2 is described in reference to a first, second and third relay. More generally, the described method may include any number of relays, where each relay is separately designated as a primary, backup, or potential sympathetic relay for each of the considered fault scenarios.

### Additional Technical Description

The following numbered paragraphs provide additional information related to the described embodiments.

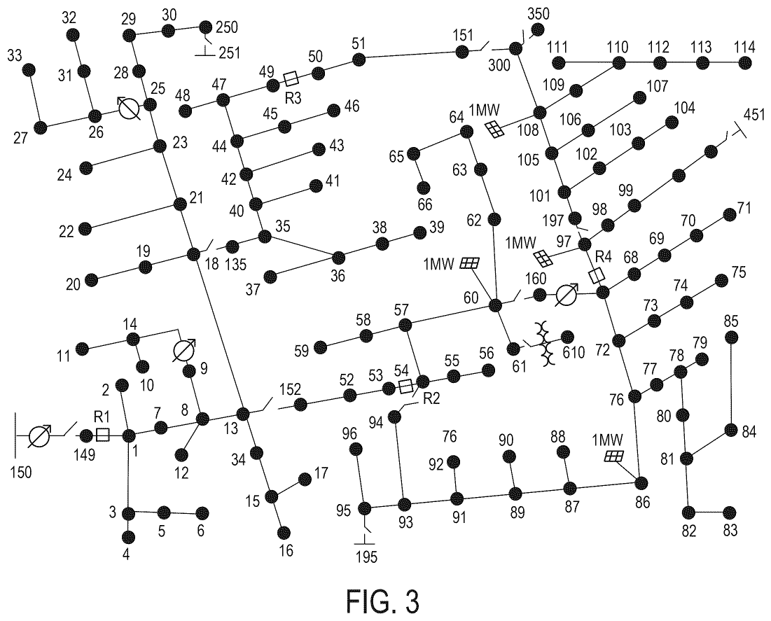

### FIG. 3—Example DER Power Distribution Network

FIG. 3 is a schematic diagram of an example DER power distribution network, according to some embodiments. The numbered nodes represent user nodes of the network (e.g., houses, apartments, etc.). The DER power sources are illustrated as 1 MegaWatt (MW) grids, and relays are labelled as number R boxes. Table 1 illustrates a default switch configuration for the network shown in FIG. 3. The example power distribution network in FIG. 3 provides an example relay architecture, and is used to describe example scenarios for fault mitigation, as described in greater detail below.

TABLE 1
Default Switch Configuration for IEEE 123-Bus Feeder

| | |
|---|---|
| Closed | 150-149, 13-152, 18-135, 60-160, 61-610, 97-197 |
| Open | 54-94, 95-195, 151-300, 300-350, 250-251, 450-451 |

In the example network shown in FIG. 3, the feeder includes 1 MW DERs—specifically, photovoltaic (PV) systems—at buses 60, 86, 97, and 108. Each PV unit is rated at 1000 kVA, equipped with a fault ride-through controller, and capable of contributing up to 150% of its rated current during fault conditions. These configurations closely mimic real-world DER characteristics, particularly the limited and variable fault current contributions typical of IBRs.

In the illustrated example network layout, relays are labels as RN for the N^{th} relay, and are placed in the network as shown below in Table 2.

TABLE 2
Relay Placement and Primary-Backup Pairs

| Relay | Location | Backup for |
|---|---|---|
| Relay-1 | Section 149-1 | Relay-2, Relay-3 |
| Relay-2 | Section 53-54 | Relay-4 |
| Relay-3 | Section 49-50 | |
| Relay-4 | Section 67-97 | |

Fault locations are selected as the buses immediately downstream from the relay locations. Specifically, the set of fault scenarios specifies the buses, that is, [symbol] ={1,54,50,97}. The fault currents I_{F}_{_{k,p(k)}} and I_{F}_{_{k,b(k)}} that each relay detects are listed in Table 3. The Node labels indicate fault locations.

TABLE 3
Fault Scenarios and Corresponding Relay Currents (in Amperes)

| | Node-1 | Node-50 | Node-54 | Node-97 |
|---|---|---|---|---|
| Relay-1 | 1291.5 | 1103.8 | 949.4 | |
| Relay-2 | | 1088.7 | | 909.8 |
| Relay-3 | | | 1237.2 | |
| Relay-4 | | | | 950.2 |

While out-of-zone relays may detect currents during fault scenarios, only the fault currents directly relevant to primary and backup relay coordination are used as inputs for determining relay operational settings. It should be emphasized that traditional protection coordination accounts for the fault currents only through the primary-backup relay pairs. Table 4 provides PSₘᵢₙ, defined as 120% of the load current, and PSₘₐₓ is the minimum fault current among the five fault types (LLLG, LLG, LG, LL, and LLL) obtained from CYME. The coordination employs the IEEE-Inverse Curve with parameter values A=0.0515, B=0.114, and ρ=0.02; CTI and Δ are both set to 0.2 s.

TABLE 4
Constraints for Relays

| | Tₘᵢₙ | Tₘₐₓ | TDSₘᵢₙ | TDSₘₐₓ | PSₘᵢₙ | PSₘₐₓ |
|---|---|---|---|---|---|---|
| Relay-1 | 0.1 | 1.1 | 0.05 | 1.1 | 283.2 | 1291.5 |
| Relay-2 | 0.1 | 1.1 | 0.05 | 1.1 | 263.3 | 1088.7 |
| Relay-3 | 0.1 | 1.1 | 0.05 | 1.1 | 21.9 | 1237.2 |
| Relay-4 | 0.1 | 1.1 | 0.05 | 1.1 | 255.0 | 950.2 |

### Performance Metrics

Embodiments herein may be tailored to improve effectiveness at sympathetic tripping mitigation according to several performance metrics, as follows:

First, parameters for setting relay operational settings may be determined to reduce fault isolation times, which is the time taken by the primary relays to detect and isolate faults within their designated zones. This metric emphasizes the performance of primary relays in terms of operating more rapidly than relays susceptible to sympathetic tripping, validating the effectiveness of the proposed prioritization scheme. Embodiments herein improve fault isolation times for primary relays by ensuring that they respond faster than relays potentially susceptible to sympathetic tripping. For instance, with the settings listed in Table 5, Relay-3 isolates faults faster than Relay-4, thereby enhancing fault management and preventing unnecessary relay activations in adjacent zones. More specifically, with the relay settings produced by the coordination formulation implemented by Equation 10, Relay-4 will act faster than Relay-3 for a fault at bus 51, following the times provided in the third column of Table 6. Embodiments herein resolve the issue of sympathetic tripping in this scenario by adjusting the relay settings so that the response time of Relay-3 is shorter than the one of Relay-4, as shown in Table 6.

TABLE 5
Relay Settings

| | |
|---|---|
| | Described |
| Traditional | Embodiments |

| Relay | TDS | PS | TDS | PS |
|---|---|---|---|---|
| Relay-1 | 0.4500 | 283.2445 | 0.4500 | 283.2445 |
| Relay-2 | 0.2500 | 263.3005 | 0.2500 | 263.3005 |
| Relay-3 | 0.2076 | 182.7555 | 0.1623 | 283.2445 |
| Relay-4 | 0.0500 | 254.9978 | 0.0500 | 254.9978 |

TABLE 6
Relay Operating Times in Response to Fault at Bus 51

| | Fault | Time with | Time with |
|---|---|---|---|
| | Current Seen | Traditional | Described |
| Relay | by Relay (A) | Coordination(s) | Embodiments |
| Relay-3 | 2006.9 | 0.5991 | 0.5689 |
| Relay-4 | 463.2 | 0.5829 | 0.5829 |

Second, parameters for setting relay operational settings may be determined to increase relay coordination efficiency, which is the ability of primary and backup relays to coordinate in response to faults. Improved coordination efficiency reflects the effectiveness of the proposed approach in ensuring reliable fault isolation without unintended relay operations.

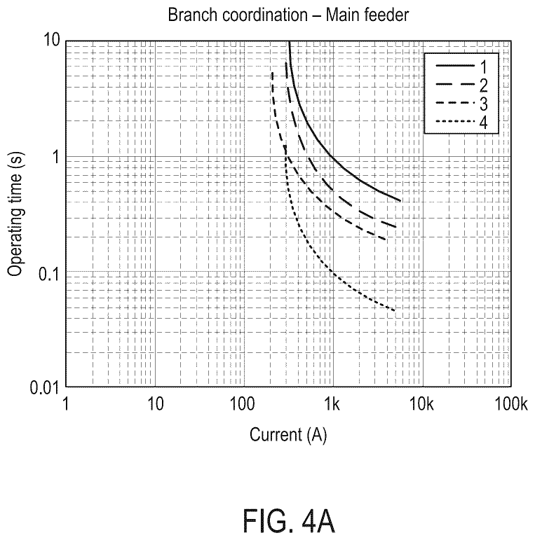

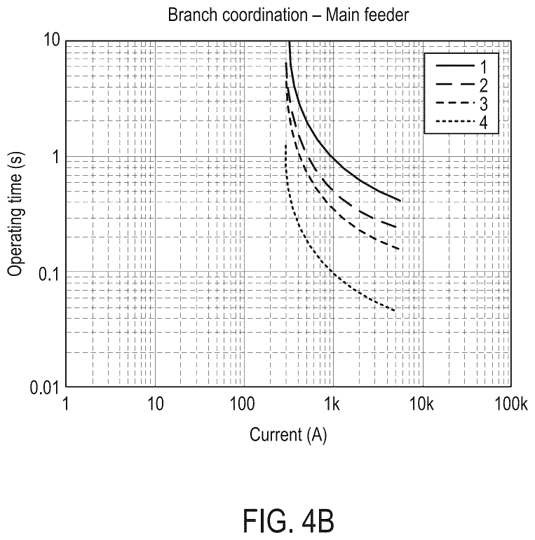

FIGS. 4A and 4B illustrate the determined time-current characteristics for all four relays in the example network shown in FIG. 3, for previous implementations (e.g., by minimizing the summation in Eq. 10) and utilizing some described embodiments (e.g., by minimizing the summation in Eq. 15), respectively. Embodiments herein ensure that primary and backup relays maintain the correct Coordination Time Interval, as demonstrated in FIG. 4B. FIG. 4B clearly shows distinct and non-overlapping relay operation times, highlighting precise coordination and effective fault isolation.

A typical situation whereby sympathetic tripping may occur involves a relay close to DERs that trips when those DERs feed a fault current elsewhere in the network. In the example network shown in FIG. 3, currents from DERs on buses 97 and 108 could sympathetically trip Relay-4 if they flow towards a fault location for which another relay, such as Relay-3, should trip. Specifically, in this example scenario, a fault occurs on bus 51, that is, [symbol] ={51}. For this scenario, the relay that should legitimately trip is Relay-3, that is, r (51)=Relay-3; and due to the presence of DERs on buses 97 and 108, a relay that may sympathetically trip is s(51)=Relay-4.

Note that the current through Relay-4 for a fault at bus 51 has the reverse direction compared to the current through Relay-4 for a fault at bus 97. Because embodiments herein focus on overcurrent relays, the reverse fault current may indeed trip the relay if it is larger than the pickup current. Further, for a fault at bus 51, Relay-2 may sympathetically trip, in addition to Relay-4. This situation may be accommodated by e.g., defining the set [symbol] ={51,51′] with s(51)=Relay-4 and s(51′)=Relay-2.

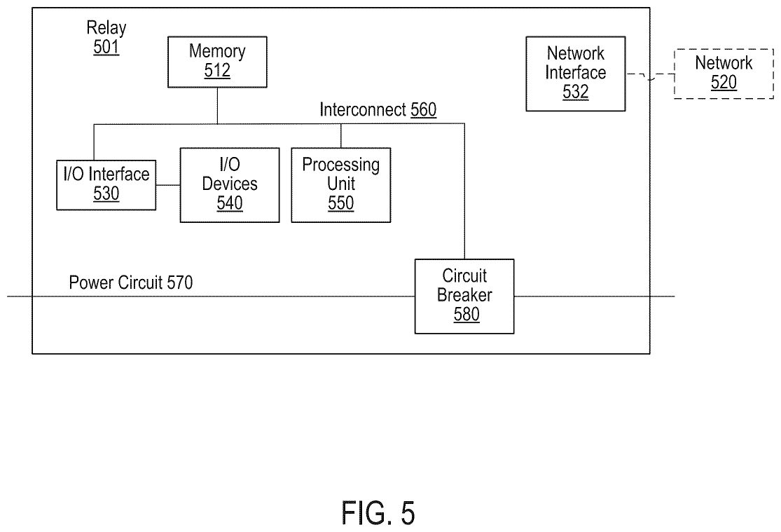

### FIG. 5—Example Power Relay

FIG. 5 is a block diagram of one embodiment of a power relay (which may also be referred to as a protective relay or simply a relay) 501 is depicted, which may be utilized in accordance with some embodiments. The relay 501 may be used to implement various portions of this disclosure. Relay 501 may be any suitable type of device that is designed to trip a circuit breaker to isolate a fault when a fault is detected. As shown, relay 501 includes processing unit 550, memory 512, and input/output (I/O) interface 530 coupled via an interconnect 560 (e.g., a system bus). I/O interface 530 may be coupled to one or more I/O devices 540. The relay 501 may further include a network interface 532, which may be coupled to a network 520 for communications with, for example, a controller configured to configure operational settings of the relay.

In various embodiments, processing unit 550 includes one or more processors. In some embodiments, processing unit 550 includes one or more coprocessor units. In some embodiments, multiple instances of processing unit 550 may be coupled to interconnect 560. Processing unit 550 (or each processor within 550) may contain a cache or other form of on-board memory. In some embodiments, processing unit 550 may be implemented as a general-purpose processing unit, and in other embodiments it may be implemented as a special purpose processing unit (e.g., an ASIC). In general, relay 501 is not limited to any particular type of processing unit or processor subsystem.

Memory 512 is usable by processing unit 550 (e.g., to store instructions executable by and data used by processing unit 550). Memory 512 may be implemented by any suitable type of physical memory media, including hard disk memory, floppy disk memory, removable disk memory, flash memory, random access memory (RAM-SRAM, EDO RAM, SDRAM, DDR SDRAM, RDRAM, etc.), ROM (PROM, EEPROM, etc.), and so on. Memory 512 may consist solely of volatile memory, in one embodiment. Memory 512 may store program instructions executable by relay 501 using processing unit 550, including program instructions executable to cause relay 501 to implement the various techniques disclosed herein. For example, the memory 512 may store operational settings for the relay, which may include a time dial setting (TDS) value and a pickup setting (PS). These operational settings may be preconfigured for the relay, or alternatively they may be dynamically modified by a controller that configures the settings, e.g., through the I/O interface and/or the network interface.

I/O interface 530 may represent one or more interfaces and may be any of various types of interfaces configured to couple to and communicate with other devices, according to various embodiments. In one embodiment, I/O interface 530 is a bridge chip from a front-side to one or more back-side buses. I/O interface 530 may be coupled to one or more I/O devices 540 via one or more corresponding buses or other interfaces. Examples of I/O devices include storage devices (hard disk, optical drive, removable flash drive, storage array, SAN, or an associated controller), network interface devices, user interface devices or other devices (e.g., graphics, sound, etc.).

Various articles of manufacture that store instructions (and, optionally, data) executable by a computing system to implement techniques disclosed herein are also contemplated. The computing system may execute the instructions using one or more processing elements. The articles of manufacture include non-transitory computer-readable memory media. The contemplated non-transitory computer-readable memory media include portions of a memory subsystem of a computing device as well as storage media or memory media such as magnetic media (e.g., disk) or optical media (e.g., CD, DVD, and related technologies, etc.). The non-transitory computer-readable media may be either volatile or nonvolatile memory.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A power distribution network, comprising:
a first relay configured with a first time dial setting (TDS) and a first pickup setting (PS), wherein the first relay is configured to act as a primary relay for a first fault scenario at a first fault location, wherein a first operating time of the first relay for the first fault scenario is determined based at least in part on the first TDS and the first PS;
a second relay configured with a second TDS and a second PS, wherein a second operating time of the second relay for the first fault scenario is determined based at least in part on the second TDS and the second PS, and wherein the first fault location is not in a designated fault zone of the second relay;
wherein the first and second TDS and the first and second PS are determined based on performing a minimization operation of a summation of a plurality of summands, wherein the plurality of summands comprises:
the first operating time; and
an amount by which the first operating time exceeds the second operating time.

2. The power distribution network of claim 1, further comprising:
a third relay configured with a third TDS and a third PS, wherein the third TDS and the third PS determine a third operating time of the third relay, wherein the third relay is configured to act as backup relay for the first fault scenario, wherein the first fault scenario produces a third fault current at the third relay,
wherein the plurality of summands further comprises the third operating time.

3. The power distribution network of claim 1, further comprising:
one or more nodes comprising at least one distributed energy resource (DER), wherein the first fault scenario causes the one or more nodes to produce a first fault current at the first relay and a second fault current at the second relay,
wherein the first operating time is determined further based at least in part on the first fault current, and
wherein the second operating time is determined further based at least in part on the second fault current.

4. The power distribution network of claim 1,
wherein the first fault scenario produces a first fault current at the first relay,
wherein the first relay is configured to disconnect a first subcircuit of the power distribution network when a first operating time has elapsed after the first relay detects that the first fault current exceeds the first PS,
wherein the first fault scenario produces a second fault current at the second relay, and
wherein the second relay is configured to disconnect a second subcircuit of the power distribution network when a second operating time has elapsed after the second relay detects that the second fault current exceeds the second PS.

5. The power distribution network of claim 1,
wherein the first fault scenario produces a second fault current at the second relay, and
wherein performing the minimization operation comprises determining a value of a binary variable, dₗ, that indicates whether the second fault current is sufficient to trigger sympathetic tripping of the second relay for the determined second TDS and second PS.

6. The power distribution network of claim 1,
wherein the second relay is configured to act as the primary relay for a second fault scenario at a second fault location,
wherein the second fault location is not in a designated fault zone of the first relay;
wherein a third operating time of the first relay for the second fault scenario is determined based at least in part on the first TDS and the first PS,
wherein a fourth operating time of the second relay for the second fault scenario is determined based at least in part on the second TDS and the second PS,
wherein the plurality of summands further comprises:
the fourth operating time; and
an amount by which the fourth operating time exceeds the third operating time.

7. The power distribution network of claim 1,
wherein the first and second operating times are determined further based at least in part on a plurality of parameters for an institute of electrical and electronics engineers (IEEE) or international electrotechnical commission (IEC) time-current curve.

8. The power distribution network of claim 1,
wherein the first operating time is determined based at least in part on the first TDS and the first PS according to:
$${T}_{p ( k )} = A \cdot \frac{T D {S}_{p ( k )}}{{( \frac{{I}_{{F}_{k , p ( k )}}}{{PS}_{p ( k )}} )}^{ρ} - 1} + B \cdot {TDS}_{p ( k )} ,$$
wherein Tₚ₍ₖ₎ is the first operating time, TDSₚ₍ₖ₎ is the first TDS, PSₚ₍ₖ₎ is the first PS, I_{F}_{_{k,p(k)}} is a fault current through the first relay during the first fault scenario, and A, B and ρ are parameters.

9. The power distribution network of claim 1,
wherein the first relay is configured to act as a primary relay or a backup relay for the first fault scenario.

10. A non-transitory computer-readable memory medium storing program instructions which, when executed by a processor, cause a computing device to:
for each of a plurality of fault scenarios, l, at a plurality of respective fault locations:
identify a first relay, r(l), that should legitimately trip as a primary relay during the fault scenario;
identify a second relay, s(l), that may sympathetically trip during the fault scenario;
determine a first fault current through the first relay during the fault scenario; and
determine a second fault current through the second relay during the fault scenario;
determine first operational settings of the first relay and second operational settings of the second relay by performing a minimization operation on a summation of a plurality of summands, wherein the operational settings comprise, for each relay of the plurality of relays, a respective time dial setting (TDS) and a respective pickup setting (PS), wherein the plurality of summands comprises:
a first operating time of the first relay, wherein the first operating time is determined based at least in part on the first operational settings and the first fault current; and
an amount by which the first operating time exceeds a second operating time of the second relay, wherein the second operating time is determined based at least in part on the second operational settings and the second fault current; and
store the first and second operational settings in the non-transitory computer-readable memory medium.

11. The non-transitory computer-readable memory medium of claim 10, wherein the program instructions are further executable to cause the computing device to:
for each of the plurality of fault scenarios:
identify a third relay, b(l), that should legitimately trip as a backup relay during the fault scenario;
determine a third fault current through the third relay during the fault scenario;
determine third operational settings of the third relay by performing the minimization operation on the summation of the plurality of summands, wherein the plurality of summands further comprises a third operating time of the third relay, wherein the third operating time is determined based at least in part on the third operational settings and the third fault current.

12. The non-transitory computer-readable memory medium of claim 10, wherein the program instructions are further executable to cause the computing device to:
configure the first relay with the first operational settings; and
configure the second relay with the second operational settings.

13. The non-transitory computer-readable memory medium of claim 10,
wherein performing the minimization operation comprises determining a value of a binary variable, dₗ, that indicates whether the second fault current is sufficient to trigger sympathetic tripping of the second relay for the determined second operational settings.

14. The non-transitory computer-readable memory medium of claim 10,
wherein, when the first operating time does not exceed the second operating time, the amount by which the first operating time exceeds the second operating time is treated as zero.

15. The non-transitory computer-readable memory medium of claim 10,
wherein the first operating time is determined based at least in part on the first TDS and the first PS according to:
$${T}_{p ( k )} = A \cdot \frac{T D {S}_{p ( k )}}{{( \frac{{I}_{{F}_{k , p ( k )}}}{{PS}_{p ( k )}} )}^{ρ} - 1} + B \cdot {TDS}_{p ( k )} ,$$
wherein Tₚ₍ₖ₎ is the first operating time, TDSₚ₍ₖ₎ is the first TDS, PSₚ₍ₖ₎ is the first PS, I_{F}_{_{k,p(k)}} is a fault current through the first relay during the first fault scenario, and A, B and ρ are parameters.

16. A method for determining operational settings a plurality of relays in a power distribution network,
wherein the operational settings comprise, for each relay of the plurality of relays, a respective time dial setting (TDS) and a respective pickup setting (PS),
the method comprising:
for each of a plurality of fault scenarios, l, at a plurality of respective fault locations:
identifying a first relay, r(l), that should legitimately trip as a primary relay during the fault scenario;
identifying a second relay, s(l), that may sympathetically trip during the fault scenario;
determining a first fault current through the first relay during the fault scenario; and
determining a second fault current through the second relay during the fault scenario;
determining first operational settings of the first relay and second operational settings of the second relay by performing a minimization operation on a summation of a plurality of summands, wherein the plurality of summands comprises:
a first operating time of the first relay, wherein the first operating time is determined based at least in part on the first operational settings and the first fault current; and
an amount by which the first operating time exceeds a second operating time of the second relay, wherein the second operating time is determined based at least in part on the second operational settings and the second fault current.

17. The method of claim 16,
wherein performing the minimization operation comprises determining a value of a binary variable, dₗ, that indicates whether the second fault current is sufficient to trigger sympathetic tripping of the second relay for the determined second operational settings.

18. The method of claim 16,
wherein, when the first operating time does not exceed the second operating time, the amount by which the first operating time exceeds the second operating time is treated as zero.

19. The method of claim 16, further comprising:
for each of the plurality of fault scenarios:
identifying a third relay, b(l), that should legitimately trip as a backup relay during the fault scenario;
determining a third fault current through the third relay during the fault scenario;
determining third operational settings of the third relay by performing the minimization operation on the summation of the plurality of summands, wherein the plurality of summands further comprises a third operating time of the third relay, wherein the third operating time is determined based at least in part on the third operational settings and the third fault current.

20. The method of claim 16, further comprising:
configuring the first relay with the first operational settings; and
configuring the second relay with the second operational settings.
